(19) United States
(12) Patent Application Publication
(10) Pub. No.: US 2014/0016938 A1
(43) Pub. Date: Jan. 16, 2014

(54) TEMPERATURE ADJUSTABLE CHANNEL TRANSMITTER SYSTEM INCLUDING AN INJECTION-LOCKED FABRY-PEROT LASER

(71) Applicants: Leif J. Sandstrom, Madison, AL (US); Kevin Wayne Schneider, Huntsville, AL (US)

(72) Inventors: Leif J. Sandstrom, Madison, AL (US); Kevin Wayne Schneider, Huntsville, AL (US)

(73) Assignee: ADTRAN, INC., Huntsville, AL (US)

(21) Appl. No.: 13/546,478

(22) Filed: Jul. 11, 2012

(51) Int. Cl. H04J 14/02

(52) U.S. Cl. 398/72; 398/79

(57) ABSTRACT

A tunable channel transmitter system for a wavelength division multiplexed (WDM) passive optical network (PON) includes a WDM communication system having a plurality of WDM channel bandwidths, an injection-locked Fabry-Perot laser having a plurality of resonant modes, a seed light source to provide seed light to the injection-locked Fabry-Perot laser, and a temperature control element configured to shift the plurality of resonant modes of the injection-locked Fabry-Perot laser to ensure that only one resonant mode of the injection-locked Fabry-Perot laser is locked to the seed source and transmitting a substantial portion of the laser power through a desired channel of the WDM communications system.

### BACKGROUND

A wavelength division multiplexed (WDM) communication system (such as a WDM-passive optical network (PON)), can be implemented using tunable lasers as the optical transmitting elements. As used herein, “tuning” a laser refers to the process of altering the laser's wavelength of operation in a controlled manner. This is often done in dense WDM (DWDM) systems, operating at transmission speeds of 10 gigabits per second (Gbps) and higher. The lasers and the transceivers they are contained in are relatively expensive because the tuning process requires both accuracy and precision in the tuning functionality. An accurate wavelength reference is needed along with a precise mechanism for changing the wavelength of the laser and a control loop for locking the laser wavelength to a particular reference value. To lower the cost of tunable WDM systems and make them more suitable for residential applications, which are cost sensitive, methods have been developed to eliminate the need for a local wavelength reference. However, to achieve high data rates, a precisely controllable single mode laser that is tunable across a fairly wide wavelength range is still required.

Another approach to achieving low-cost flexible WDM systems is to use injection-locked lasers for the channel laser sources. These injection-locked Fabry-Perot (IL-FP) laser devices respond to input stimulus (the “seed” light) provided by the WDM system, enabling the IL-FP to lock on to the desired wavelength. In a particular implementation, an IL-FP laser receives a low power “seed” light provided by a network element and responds by locking to the wavelength of the seed light and transmitting most of its power at that wavelength. This allows substantially identical Fabry-Perot channel laser sources to be implemented on all channels of the WDM system, while allowing each channel laser source to transmit at a unique desired wavelength. Such channel laser sources facilitate simplified inventory management by allowing substantially similar channel laser devices to be implemented across a WDM-PON. This provides functionality that is similar to that obtained from the tunable WDM system at a potentially lower cost.

Current commercial IL-FP WDM systems use IL-FP transmitters with a cavity length sufficiently long to ensure that multiple natural resonant lasing modes will overlap with each WDM channel. This practice is done to ensure that at least one lasing mode of the IL-FP will be stimulated by the seed light source such that reliable wavelength locking and stable power output from the laser occur. However, the long cavity length limits the maximum data rate per channel due to mode-partition noise and capacitive coupling.

The WDM system channel grid is typically determined by an arrayed waveguide grating (AWG) (or other wavelength filtering device used as the wavelength multiplexer/demultiplexers in the WDM system). With typical values for the IL-FP cavity length of 500-1000 micrometers (μm), 100 gigahertz (GHz) AWG channel spacing and a Broadband Light Source (BLS) for the seed source, data rates of approximately 1.25 Gbps have been demonstrated using this technology. However, because of the limitations described herein, achieving higher data rates is difficult and requires changing the seed source and/or externally modulating the light from the laser. Externally modulating the light from the laser adds cost to the system and is not compatible with the objective of providing the WDM functionality at low cost. Therefore a WDM system that employs directly modulated IL-FP lasers for channel adaptivity and that can avoid mode partition noise and other impairments, and thus achieve higher data rates, is desirable.

### SUMMARY

In an embodiment, a tunable channel transmitter system for a wavelength division multiplexed (WDM) passive optical network (PON) includes a WDM communication system having a plurality of WDM channel bandwidths, an injection-locked Fabry-Perot laser having a plurality of resonant modes, a seed light source to provide seed light to the injection-locked Fabry-Perot laser, and a temperature control element configured to shift the plurality of resonant modes of the injection-locked Fabry-Perot laser to ensure that only one resonant mode of the injection-locked Fabry-Perot laser is locked to the seed source and transmitting a substantial portion of the laser power through a desired channel of the WDM communications system.

Other embodiments are also provided. Other systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1A is a block diagram illustrating a simplified communications system implemented as a WDM-PON having a tunable injection-locked transmitter at the ONT.

FIG. 1B is a block diagram illustrating a transceiver of FIG. 1A in greater detail.

FIG. 2 is a graphical illustration showing a detailed view of a WDM-PON channel grid.

FIG. 3 is a schematic diagram illustrating an example of an optical cavity of an IL-FP laser device having a temperature control element.

FIG. 4 is an example channel grid spacing diagram and illustrates how example IL-FP output modes can align with the channel grid.

FIG. 5 is a flow chart describing the operation of a first embodiment of a temperature adjustable injection locked Fabry-Perot laser.

FIG. 6 is a flow chart describing the operation of a second embodiment of a temperature adjustable injection locked Fabry-Perot laser.

### DETAILED DESCRIPTION

Generally, wavelength division multiplexed (WDM) systems form a class of communication systems which support a number of independent communications channels each on an independent optical wavelength. The channel spacing is often based on the standardized dense wave division multiplexing (DWDM) channel grid used for transport networks, as per ITU-T G.694.1, “Spectral Grids for WDM applications: DWDM frequency grid,” May 2002. Common standardized channel spacings include 200 GHz, 100 GHz, 50 GHz, 25 GHz and 12.5 GHz. For a WDM-PON system, the 200 GHz and 100 GHz grids are most common, with the ITU-T 100 GHz grid between approximately 1530 nanometers (nm) and 1570 nm, occupying what is referred to as the “C” band, being of particular interest.

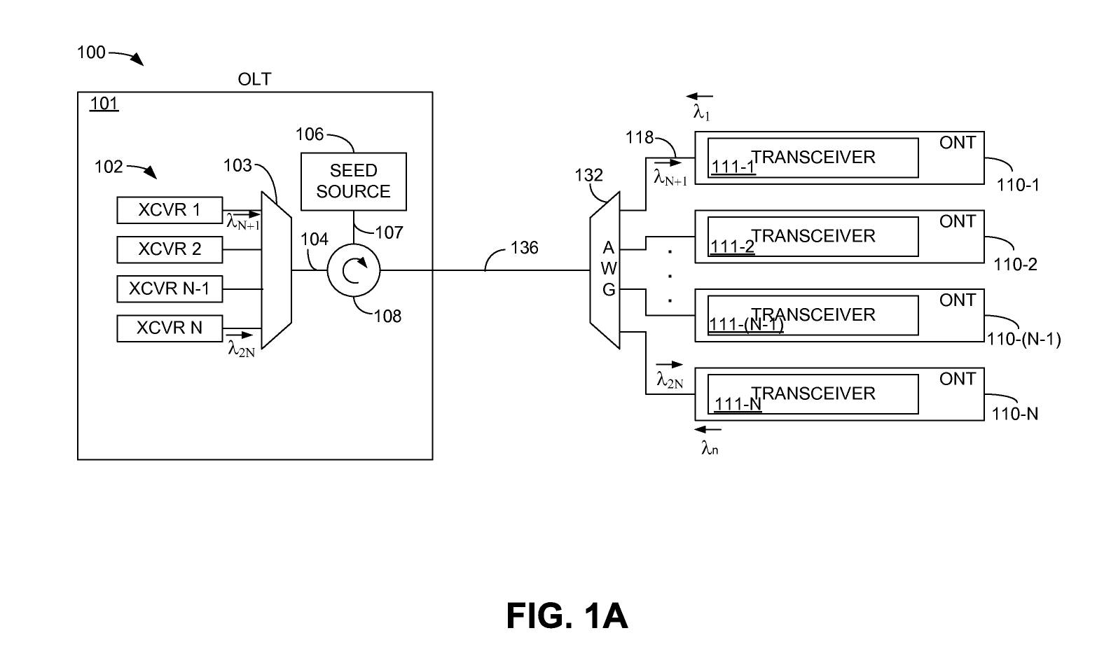

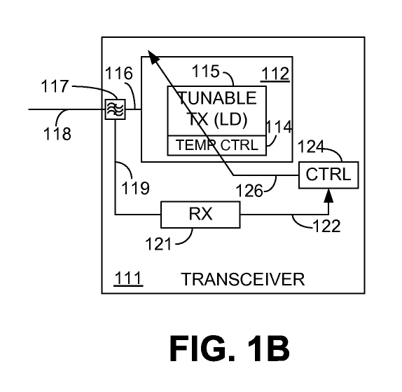

FIG. 1A is a block diagram illustrating a simplified communications system 100, implemented as a WDM-PON having a tunable injection-locked transmitter at the optical network terminal (ONT). WDM-PON systems typically have a single optical line terminal (OLT) 101 which includes multiple transmitters and many ONTs 110, each of which includes a single transceiver 111. For operational simplicity, it is desired for the ONTs to each use transceivers that are substantially similar, even though they will operate on different WDM channels.

The WDM-PON communication system 100 comprises an optical fiber trunk 136 connected to an arrayed waveguide grating (AWG) 132. The AWG 132 is connected via separate optical connections 118 to a plurality of ONTs 110, each containing a transceiver 111. The transceivers 111 will be referred to using the nomenclature 111-N, where “N” is the number of substantially identical ONTs or transceivers. Only a single transceiver 111-1 will be described in detail for simplicity. The transceiver 111-1 is coupled to the AWG 132 over optical connection 118. As known in the art, an AWG is a passive optical element which is used to optically multiplex a number of different transmit wavelengths from transceivers 111-1 through 111-N over the optical fiber trunk 136, and demultiplex receive optical wavelengths (from the opposite end of a bidirectional system) and pass them to the transceivers 111-1 through 111-N. As an example, a single wavelength, λ₁ is provided from the transceiver 111-1; and a single wavelength, λ_{N+1} is provided to the transceiver 111-1. In the same embodiment and at the same time, another single wavelength, λ_{N}, is provided from the transceiver 111-N; and a single wavelength, λ_{2N} is provided to the transceiver 111-N. The AWG 132 routes these wavelengths to and from the correct transceivers and multiplexes these wavelengths onto the optical trunk fiber 136.

The OLT 101 is coupled to the optical fiber trunk 136 and includes transceivers 102 that transmit to the ONTs 110 at the proper wavelengths λ_{N+1} to λ_{2N}). The transceivers 102 in the OLT are coupled to the optical fiber trunk 136 through a WDM multiplexer 103 such as an AWG. The OLT 101 may also include a seed source 106 that can inject an optical seed signal via an optical circulator 108. The seed light provided by the seed source 106 is used by the ONT transceivers 111 to transmit on the proper wavelength.

FIG. 1B is a block diagram illustrating a transceiver of FIG. 1A in greater detail. The transceiver 111 comprises a tunable channel transmitter 112 and a receiver 121. In an embodiment, the tunable channel transmitter 112 comprises a directly modulated injection locked Fabry-Perot (IL-FP) laser device 115 that is used as an optical transmitter and a temperature control element 114 which is used to alter the wavelengths of the resonant modes of the laser. The tunable channel transmitter 112 is coupled to a filter 117 over an optical connection 116. The filter 117 separates transmit and receive signals, whereby transmit signals are directed over connection 116 and receive signals are directed to the receiver 121 over connection 119. Although illustrated as separated by frequency (or wavelength) by the filter 117, other ways of separating transmit and receive signals are known to those skilled in the art and are contemplated to be within the scope of the transceiver described herein.

In an embodiment, the receiver 121 is coupled to a control element 124 over connection 122. The control element 124 can be used to control various operational aspects of the tunable channel transmitter 112 over control connection 126. In an embodiment, the tunable channel transmitter 112 includes a temperature control element 114 located in proximity to the IL-FP laser device 115. The temperature control element 114 can be a thermo-electric device, a resistive heating element, or can be any other temperature control element that is located in proximity to the lasing cavity of the IL-FP laser device 115 such that the output characteristics of the IL-FP laser device 115 may be altered by the temperature control element 114. In an embodiment, the control element 124 provides a control signal over control connection 126 that can be used to control the operation of the temperature control element 114. In this manner, and as will be described in greater detail below, the operational wavelength of the IL-FP laser device 115, and therefore, the tunable channel laser 112, can be controlled by the temperature control element 114.

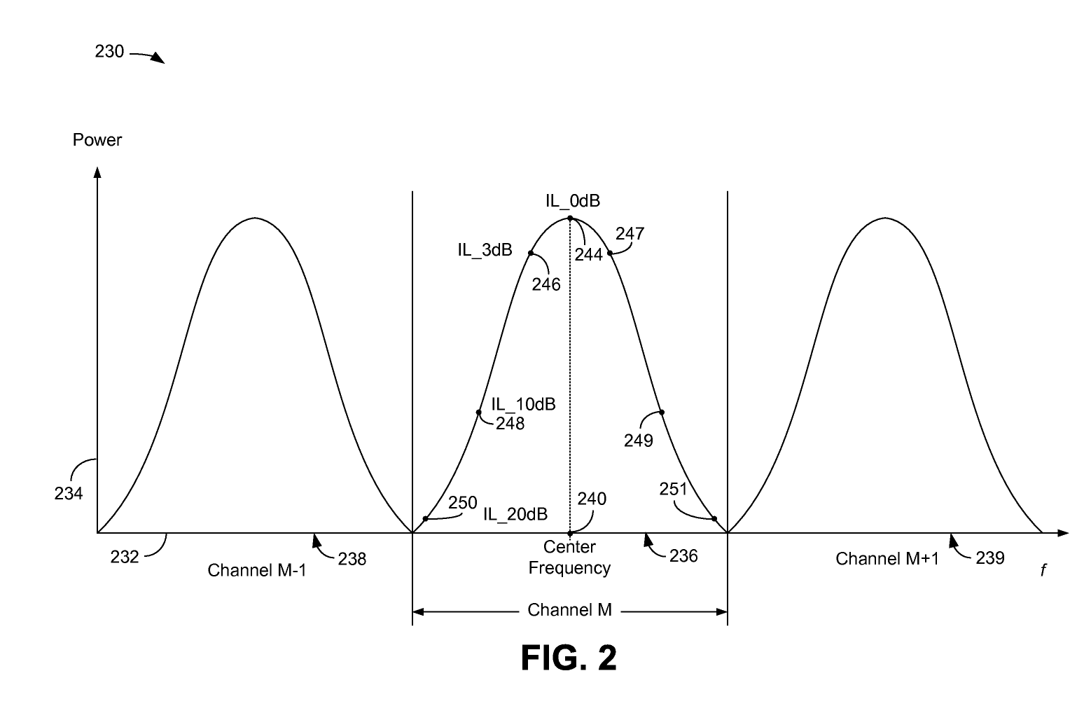

FIG. 2 is a graphical illustration showing a detailed view of a WDM-PON channel grid. The elements in FIG. 2 are for example purposes only, are not to scale, and are intended to be representative of three adjacent channels in the AWG 132 with a 100 GHz grid of Gaussian shaped channels. Other grid spacings and channel shapes are possible. The horizontal axis 232 represents relative frequency (f) and the vertical axis 234 represents relative power. The illustration 230 includes channels 236, 238 and 239. For example purposes only, the channel 236 is considered to be the “desired channel,” referred to as channel M. The channel 238 (channel M−1) is located adjacent the channel 236 at a frequency (wavelength) that is lower (longer) than the frequency (wavelength) at which the channel 236 is located. Similarly, the channel 239 (channel M+1) is located adjacent the channel 236 at a frequency (wavelength) that is higher (shorter) than the frequency (wavelength) at which the channel 236 is located.

The minimum insertion loss thru the desired AWG channel 236, IL_{—}0 dB 244, occurs at the center frequency 240 of the channel 236. The insertion loss thru the channel 236 increases by 3 dB, relative to IL_{—}0 dB, at IL_{—}3 dB, corresponding to points 246 and 247. The insertion loss thru the channel 236 increases by 10 dB, relative to IL_{—}0 dB, at IL_{—}10 dB, corresponding to points 248 and 249. The insertion loss thru the channel 236 increases by 20 dB, relative to IL_{—}0 dB, at IL_{—}20 dB, corresponding to points 250 and 251. For a theoretical 100 GHz Gaussian AWG channel, IL_{—}3 dB is approximately 15 GHz from the center frequency 240, IL_{—}10 dB is approximately 27.5 GHz from the center frequency 240, and IL_{—}20 dB is approximately 37.5 GHz from the center frequency 240. The AWG channel shapes, and therefore these values, vary widely.

In conventional WDM systems, the transmitter 112 in the transceiver 111 may be a fixed wavelength laser that transmits at a wavelength that corresponds to the center frequency 240 of the desired AWG channel 236. The transmitter 112 may also be a tunable laser, with a transmission wavelength that can be tuned to match the center frequency 240 of the desired AWG channel 236. However, specialized fixed wavelength transmitters and wide-band tunable transmitters are too expensive for many applications, particularly those in the access network, either in component cost (for the case of a wide-band tunable transmitter), operational cost (for the case of the fixed wavelength transmitter), or both. In an effort to reduce transmitter costs, a reflective semiconductor optical amplifier (RSOA) or an injection-locked Fabry Perot (IL-FP) laser have been used for the transmitter 112. Both the RSOA and the IL-FP can be made to transmit at the center frequency 240 of the desired AWG channel 236 by providing an external seed source 106 (FIG. 1) that injects an optical signal at the center frequency 240 of the desired AWG channel 236 directly into the RSOA or IL-FP. This seed light may be a broad-band light source (BLS) or coherent light source such as another laser. Alternatively, the RSOA or IL-FP may be “self-seeded” when a portion of the output signal generated by the RSOA or IL FP is returned from the trunk fiber 136 using a tap and mirror or similar arrangement, filtered by the desired AWG channel 236 and injected back into the RSOA or IL-FP as the seed light.

Among the transmitter options discussed above, IL-FPs are currently the most cost-effective. In an embodiment, an IL-FP laser is used as the transmitter 112 in the WDM-PON system 100. IL-FP lasers have a specialized structure that enables reliable injection-locking on any desired channel 236 of the AWG 132 in the WDM-PON 100.

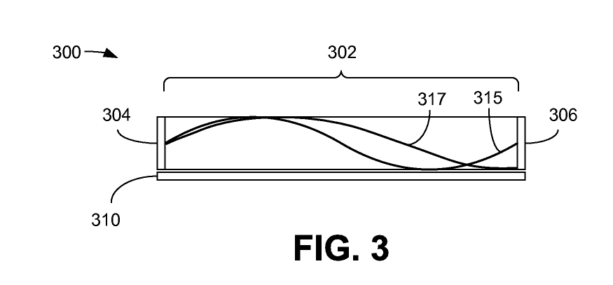

FIG. 3 is a schematic diagram 300 illustrating an example of an optical cavity of an IL-FP laser device. The example of FIG. 3 omits many of the structural elements of an IL-FP laser device and is intended to schematically illustrate an optical cavity. The effective optical cavity 302 exists between the reflectors 304 and 306. The atypically long length of this optical cavity is the feature unique to IL-FP lasers that is relevant to this discussion. The IL-FP is usually designed with a long (600 um-800 um) optical cavity to ensure reliable injection locking and consistent output power by squeezing the resonant modes of the IL-FP closer together.

The resonant modes of the IL-FP are related to the IL-FP cavity length by

2nl=mλ Eq. 1

In Eq. 1, n is the refractive index of the cavity, l is length of the optical cavity, λ is the signal wavelength. For wavelengths that satisfy Eq. 1, the round-trip cavity length, 2 l, is an integer, m, number of wavelengths. These lightwaves will interfere constructively with themselves as they transit the optical cavity 302 such that they resonate. Wavelengths that fail to meet the criteria of Eq. 1, are canceled by destructive interference. Wave 315 illustrates a wave that will experience constructive interference and wave 317 illustrates a wave that will experience destructive interference. Thus the wave 315 illustrates a “resonant mode” of the optical cavity 302 that meets the criteria of Eq. 1.

The free spectral range (FSR) or frequency spacing of the resonant modes of the optical cavity is

$$Δ f = {f}_{M + 1} - {f}_{M} = \frac{c}{2 nl} \qquad Eq . 2$$

such that Δf is inversely proportional to l. Lengthening the IL-FP cavity is intended to ensure that multiple IL-FP resonant modes fall within the desired AWG channel 236 in order to guarantee injection-locking and stabilize IL-FP output power without taking steps to align resonant modes with the injection seed and center frequency 240 of the channel 236.

Though theoretically simple to use, the IL-FP with an extended cavity has a number of inherent disadvantages. The long cavity increases the capacitive coupling in the laser thereby limiting the modulation bandwidth of the device. The excitation of more than one resonant mode in the cavity can cause mode competition or mode partition noise (MPN), degrading performance over a fiber channel. Finally, if no steps are taken to align modes with the center frequency 240 of the channel 236 and the seed source, either output power fluctuations become inevitable (with a narrow linewidth seed) or ASE noise is added to the system (with a BLS seed). Either approach further compromises performance.

It is desirable to 1) improve the modulation bandwidth of the IL-FP transmitter thereby improving WDM-PON capacity, 2) reduce or eliminate MPN, and 3) ensure reliable injection locking and stable output power.

Shortening the IL-FP cavity 302 addresses the first and second objectives listed above. A shorter cavity 302 reduces the capacitive coupling in the laser so that it can be driven at a higher data rate. In addition, a sufficiently short optical cavity 302 ensures that that only one of the resonant modes of the IL-FP laser lies within the desired AWG channel 236 at a time, thereby eliminating MPN. For example, assuming a WDM-PON with 100 GHz channel spacing and letting Δf=100 GHz, and n≈3.5, Eq. 2 can be solved for 1, resulting in a cavity length of approximately 430 μm. As stated above, this example is merely a theoretical example to illustrate the relationship between cavity length and mode spacing. For example, it may be desirable to establish mode spacing less than the channel spacing, for example, on the order of ½ of the channel spacing. In contrast, in order to allow higher direct modulation speeds, it may be desirable to shorten the cavity length such that mode spacing is greater than channel spacing (for example, one mode for every L channels). In general, it is desirable to have the resonant modes as close together as possible while reducing the previously mentioned impairments sufficiently to allow fast transmission. Optimal IL-FP resonant cavity dimensions will vary based on the PON channel spacing and are influenced by a number of factors such as, for example, the refractive index of the IL-FP laser semiconductor material and the IL-FP structure.

Though shortening the IL-FP resonant cavity 302 improves the modulation bandwidth of the IL-FP transmitter, thereby improving WDM-PON capacity, and reducing or eliminating MPN, it makes reliable injection locking and stable output power more difficult to achieve. Wide mode spacing means that no resonant modes may lie sufficiently close to the center 240 of the desired AWG channel 236 (FIG. 2) to minimize loss through the channel. In addition, the wavelength of the given resonant mode of the IL-FP may not lie close enough to the wavelength of the seed light to ensure that the IL-FP laser will reliably lock onto the wavelength of a seed light. Both considerations result in dramatic variations in output power and performance.

In order to ensure that one of the multiple resonant modes of the laser lies sufficiently close to the center 240 of the desired WDM channel 236 (FIG. 2) as well as to the wavelength of the seed light, a narrow-band tuning mechanism is applied to the laser device. A narrow-band tuning mechanism can be used to adjust the wavelengths of the resonant modes such that one resonant mode will align with the center wavelength of the desired WDM channel and the wavelength of the seed light, thus ensuring that the IL-FP laser will lock onto the wavelength of the seed light and experience minimum loss thru the channel. A variety of tuning mechanisms such as temperature control, bias current control and phase control exist in the art.

Using the temperature control element 310 (FIG. 3) to change the temperature of the IL-FP laser device causes changes in the output spectrum of the laser device. The thermal energy added to the optical cavity 302 by the temperature control element 310 changes both the cavity length and the effective refractive index of the cavity. Consequently, with increasing temperature, the laser modes are shifted toward longer wavelengths by approximately 0.1 to 0.4 nm/° C. of temperature change. The temperature control element 310 can be used to change the temperature of the IL-FP laser device and thereby shift a resonant mode to the center of the desired channel 236. As used herein, the term “shift” refers to any relative motion between one or more resonant modes and the desired channel. For example, the term “shift” can denote changing the frequency (or wavelength) of one or more of the resonant modes, altering the IL-FP optical cavity so that the resonant modes move relative to the desired channel 236, or can denote any other relative movement between the one or more resonant modes and the desired channel 236. The applied temperature variation and tuning range will vary based on the WDM-PON channel spacing and the IL-FP laser characteristics. In an embodiment implemented in a WDM-PON having 100 GHz (˜0.8 nm) channel spacing with resonant modes also spaced 100 GHz apart (using an IL-FP laser having an optical cavity on the order of 430 um), an approximate 2° C. to 8° C. temperature variation shifts the IL-FP resonant modes sufficiently to move a given resonant mode to the center of a WDM-PON channel 236.

In an embodiment, a tuning mechanism is implemented by controlling the temperature of the laser via a thermo-electric device. In yet another embodiment, a tuning mechanism is implemented by controlling the temperature of the laser via a resistive heating element. Using a simple resistive heating element allows one-way temperature control (heating only) to facilitate active tuning of the IL-FP and centering one IL-FP resonant mode in the desired WDM-PON channel. Provided the IL-FP temperature is sufficiently above ambient temperature, passive cooling (for example, by reducing the current flow thru a resistive heater) can also be used to keep the IL-FP output mode centered in the channel. If the ambient temperature is too close to the temperature of the optical cavity of the IL-FP for effective cooling to occur, a resistive heater can be used to further increase the IL-FP temperature and thereby shift an adjacent IL-FP mode into alignment with the channel. Shifting from one mode to another is known as “mode hopping”. Mode hops are predictable and can be compensated by buffering data if needed during such transition periods.

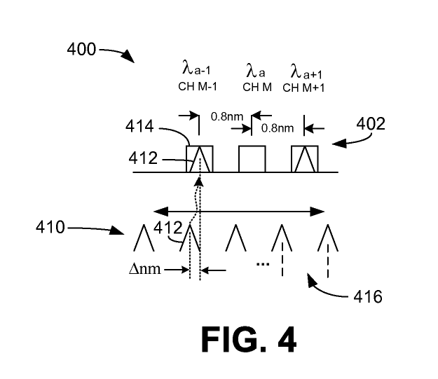

FIG. 4 is an example channel grid spacing diagram 400 and illustrates how example IL-FP output modes can align with the channel grid. The channels 402 in the embodiment of the WDM-PON shown in FIG. 4 depict a communication system operating at 100 GHz channel grid spacing, in which the individual channels 402 are spaced approximately 0.8 nm apart. However, this is one of a number of possible channel grid spacings that can be implemented in a WDM-PON with the temperature adjustable IL-FP laser described herein. Each channel 402 has a center frequency and a range of frequencies greater than and less than the center frequency. The resonant modes 410 of the IL-FP laser device are shown in the channel spacing diagram below the channels 402. When the free spectral range (FSR) 416 of the IL-FP resonant modes 410 is equal to or greater than the channel grid spacing (0.8 nm in this example), then no more than one resonant mode can be held near the center of a channel 402 at a time. When the IL-FP is not injection locked with a seed-light, the resonant modes 410 are considered to be “free running” or “uncontrolled” in that the resonant modes are naturally produced by the laser and none of the resonant modes may align with a desired channel 414. In this example, by using the temperature control element 114, associated with each channel transmitter 112, the IL-FP resonant modes can be shifted to ensure that one resonant mode, for example, resonant mode 412, is aligned with a desired WDM-PON channel, such as channel 414. The temperature-induced shift in the wavelength of the resonant mode 412 is illustrated in FIG. 4 as Δnm.

In an embodiment, the resonant mode 412 of the injection-locked Fabry-Perot laser that is locked to the seed source and transmitting a substantial portion of the laser power through a desired channel of the WDM communications system is the resonant mode which has an uncontrolled wavelength that is closest to the center wavelength of the WDM channel 414. In another embodiment, the one resonant mode 412 of the injection-locked Fabry-Perot laser that is locked to the seed source and transmitting a substantial portion of the laser power through a desired channel of the WDM communications system is a resonant mode which has an uncontrolled wavelength that is shorter than the center wavelength of the WDM channel 414.

As a given IL-FP mode 412, is shifted from the edge of the channel 236 toward the center 240 of the channel 236, the loss it experiences through the channel 236, relative to loss at the center frequency 244, decreases from 20 dB at point 250, to 10 dB at point 248, to 3 dB at point 246, to 0 dB at point 244. Monitoring these relative changes in transmitted power provides a control signal for temperature tuning. In an embodiment, the control element (124, FIG. 1B) can be used as part of a feedback control loop to enable stable operation over time.

Algorithms to control the alignment of the IL-FP laser device modes include, but are not limited to, passing tuning information from the remote transceiver or from the OLT to a receive photodiode located in each channel receiver. One such algorithm is described in US Patent Application Publication No. 2011/0236017. This is easily done if, for example, the information is sent on a wavelength separated from the transmit wavelength of the IL-FP in question by the free-spectral range (FSR) of the AWG. The tuning information can even be overlaid on data traffic (e.g., using a small, low-frequency signal modulated over the main signal) intended for the transceiver in question without disrupting data transmission. The tuning information is retrieved and processed by the control element 124, which then adjusts the current flowing thru the temperature control element 114 as needed to achieve or maintain IL-FP mode alignment with the assigned WDM-PON channel.

Referring back to FIGS. 1A and 1B, assuming that the IL-FP laser device 115 is the device being tuned, the OLT 101 can provide received power data pertaining to the power output of the IL-FP laser device 115 to the transceiver 111-1. The received power data can be used by the control element 124 to precisely control the amount of heat generated or absorbed by the temperature control element 114. This change in temperature, in turn, will change the wavelengths of the resonant modes of the IL-FP laser. The control element in effect controls the wavelength in a manner that allows it to be best aligned with the seed source and the channel, thus ensuring reliable injection locking and stable output power from laser transmitter 112. This method of producing the small temperature variations needed for narrow-band tuning is of much lower complexity than methods used to tune a single-mode laser over the entire range of channels used in a WDM-PON.

While allowing only one resonant mode of the IL-FP laser in the channel at a given time is sufficient to eliminate MPN, the resonant modes need only to be spaced wide enough relative to the seed source spectral width (line width) and the channel bandwidth such that when the transmitter is seeded, operating in steady state, and tuned on center, a single resonant mode of the IL-FP laser (the locked mode) is locked to the seed source and transmitting a substantial portion of the laser power through a desired channel of the WDM communications system. The terms “centered” and “tuned on center” refer to a condition where the locked mode is aligned with the seed wavelength and/or the center of the channel bandwidth, the specifics of which are determined by the channel and seed light characteristics. For example, referring to FIG. 2, the “center of the channel bandwidth” is between the IL_{—}3 dB points 246 and 247 which, for an AWG with 100 GHz channel spacing, can be between 20 and 50 GHz wide for a Gaussian channel and between 40 and 80 GHz wide for a Flat-top channel. The precise percentage of the laser power contained in the locked mode is implementation dependent and depends at least on laser and seed source characteristics, channel characteristics and system level characteristics such as the link budget and required error rate. The term “substantial” refers to a condition where at least some power may be contained in other modes as long as the power contained in other modes is small enough that the communications channel can still meet the desired performance. For example, an injection locked Fabry-Perot laser in a transmitter with a side-mode suppression ratio (SMSR) of at least 20 dB contains a substantial portion of the laser power in a single mode. The term “SMSR” is defined as the ratio of the peak power in the mode “tuned on center” to the peak power in the nearest adjacent mode.

A narrow linewidth seed source (such as provided by the seed source 106 of FIG. 1A) ensures the highest performance from an IL-FP transmitter provided the seed light overlaps one of the IL-FP modes and both the seed light and the IL-FP mode are centered in the desired channel 236. In an alternative embodiment, when a narrow linewidth seed is used and the capacitive coupling of the IL-FP does not prevent reaching the desired modulation bandwidth, a shorter IL-FP cavity may not be relevant to achieving the stated objectives because MPN is suppressed by injection locking with the narrow linewidth seed source. Therefore, in this alternative embodiment, narrow-band tuning, as outlined above, alone provides the alignment of an IL-FP mode and the seed source at the center frequency 240 of the desired channel 236, thereby improving WDM-PON capacity by reducing or eliminating MPN, and achieving reliable injection locking and stable output power.

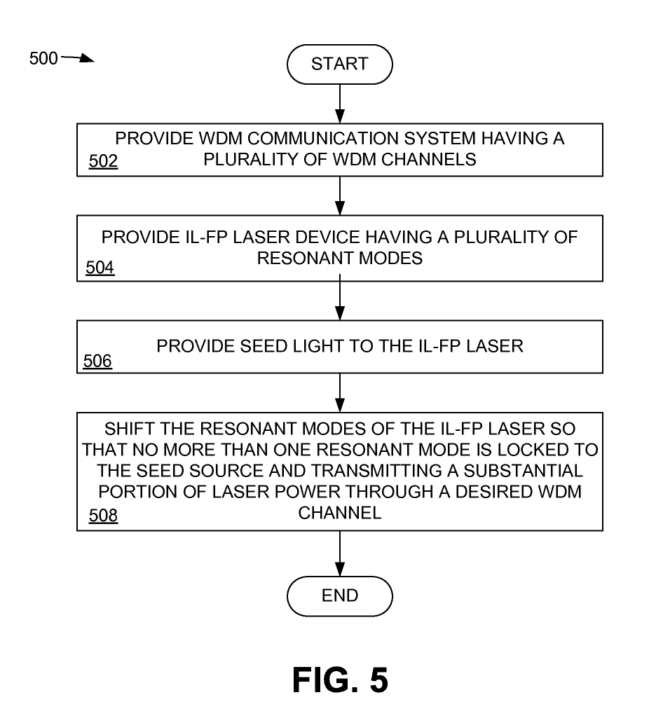

FIG. 5 is a flow chart describing the operation of a first embodiment of a temperature adjustable injection locked Fabry-Perot laser. In block 502, a WDM communication system having a plurality of WDM channels is provided. In block 504, an injection-locked Fabry-Perot laser is provided. The IL-FP laser has a plurality of resonant modes. In block 506, a seed light is provided to the injection-locked Fabry-Perot laser. In block 508, the plurality of resonant modes of the injection-locked Fabry-Perot laser are shifted to ensure that no more than one of the plurality of resonant modes of the injection-locked Fabry-Perot laser is locked to the seed source and transmitting a substantial portion of the laser power through a desired channel of the WDM communications system.

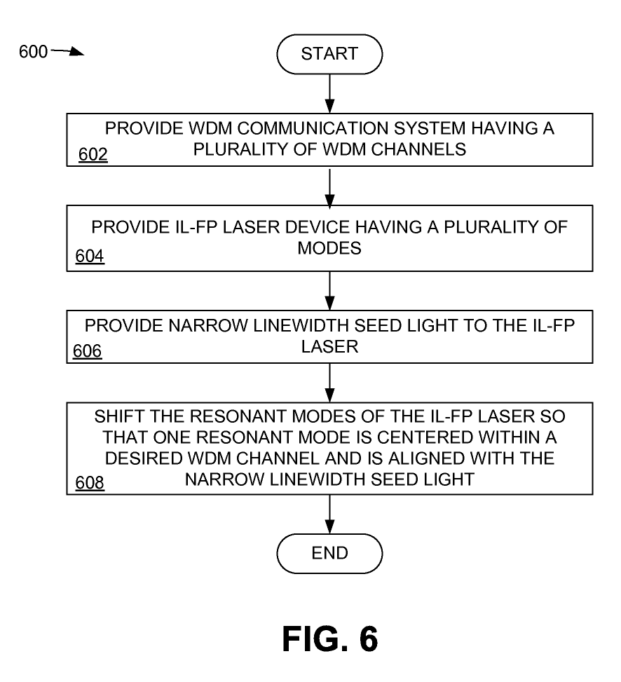

FIG. 6 is a flow chart describing the operation of a second embodiment of a temperature adjustable injection locked Fabry-Perot laser. In block 602, a WDM communication system having a plurality of WDM channels is provided. In block 604, an injection-locked Fabry-Perot laser having a plurality of resonant modes is provided. In block 606, a narrow linewidth seed light is provided to the injection-locked Fabry-Perot laser. In block 608, the plurality of resonant modes of the injection-locked Fabry-Perot laser are shifted to ensure that one resonant mode of the injection-locked Fabry-Perot laser is centered within a desired channel of the WDM communications system and is aligned with the narrow linewidth seed light.

Though shown only in use by the ONTs of a WDM-PON system, it is also possible for this invention to be applied to both ends of a bidirectional DWDM system where the transceivers at both ends (not just the ONT end) are located in separate elements.

While various embodiments of the invention have been described, it will be apparent to those of ordinary skill in the art that many more embodiments and implementations are possible that are within the scope of this invention.

What is claimed is:

1. A method for altering the wavelength of operation of a channel laser for a wavelength division multiplexed (WDM) communication system, comprising:
providing a WDM communication system having a plurality of WDM channels;
providing an injection-locked Fabry-Perot laser having a plurality of resonant modes;
providing a seed light to the injection-locked Fabry-Perot laser; and
shifting the plurality of resonant modes of the injection-locked Fabry-Perot laser to ensure that no more than one of the plurality of resonant modes of the injection-locked Fabry-Perot laser is locked to the seed source and transmitting a substantial portion of the laser power through a desired channel of the WDM communications system.

2. The method of claim 1, wherein the step of shifting the plurality of resonant modes includes the step of controlling the temperature of the injection-locked Fabry-Perot laser.

3. The method of claim 1, wherein the step of providing a seed light includes providing the seed light from any of an external light source and a self seeded light source.

4. The method of claim 2, wherein the temperature control comprises using a heating element.

5. The method of claim 4, wherein the heating element is a resistive heating element.

6. The method of claim 2, where the temperature control comprises using a thermo-electric device.

7. The method of claim 1, wherein the one resonant mode of the injection-locked Fabry-Perot laser that is locked to the seed source and transmitting a substantial portion of the laser power through a desired channel of the WDM communications system is a resonant mode which has an uncontrolled wavelength which is closest to the center wavelength of the WDM channel.

8. The method of claim 1, wherein the one resonant mode of the injection-locked Fabry-Perot laser that is locked to the seed source and transmitting a substantial portion of the laser power through a desired channel of the WDM communications system is a resonant mode which has an uncontrolled wavelength which is shorter than the center wavelength of the WDM channel.

9. A method for tuning a channel laser for a wavelength division multiplexed (WDM) communication system, comprising:
providing a WDM communication system having a plurality of WDM channels;
providing an injection-locked Fabry-Perot laser having a plurality of resonant modes;
providing a narrow linewidth seed light to the injection-locked Fabry-Perot laser; and
shifting the plurality of resonant modes of the injection-locked Fabry-Perot laser to ensure that one resonant mode of the injection-locked Fabry-Perot laser is centered within a desired channel of the WDM communications system and is aligned with the narrow linewidth seed light.

10. A tunable channel transmitter system for a wavelength division multiplexed (WDM) passive optical network (PON), comprising:
a WDM communication system having a plurality of WDM channel bandwidths;
an injection-locked Fabry-Perot laser having a plurality of resonant modes;
a seed light source to provide seed light to the injection-locked Fabry-Perot laser; and
a temperature control element configured to shift the plurality of resonant modes of the injection-locked Fabry-Perot laser to ensure that only one resonant mode of the injection-locked Fabry-Perot laser is locked to the seed source and transmitting a substantial portion of the laser power through a desired channel of the WDM communications system.

11. The channel transmitter system of claim 10, wherein the temperature control element comprises a heating element.

12. The channel transmitter system of claim 11, wherein the heating element is a resistive heating element.

13. The channel transmitter system of claim 10, wherein the temperature control element comprises a thermo-electric device.

14. The channel transmitter system of claim 10, wherein the one resonant mode of the injection-locked Fabry-Perot laser that is locked to the seed source and transmitting a substantial portion of the laser power through a desired channel of the WDM communications system is a resonant mode which has an uncontrolled wavelength which is closest to the center wavelength of the WDM channel.

15. The channel transmitter system of claim 10, wherein the one resonant mode of the injection-locked Fabry-Perot laser that is locked to the seed source and transmitting a substantial portion of the laser power through a desired channel of the WDM communications system is a resonant mode which has an uncontrolled wavelength which is shorter than any wavelengths that pass through the WDM channel, and which has an uncontrolled wavelength which is closest to the center wavelength of the WDM channel.
